(19) United States
(12) Patent Application Publication
(10) Pub. No.: US 2011/0198839 A1
(43) Pub. Date: Aug. 18, 2011

(54) ONE-PIECE HALF FITTING FOR AN INSULATED PIPE

(76) Inventor: Jeffrey H. Webb, Port Moody (CA)

(21) Appl. No.: 13/028,438

(22) Filed: Feb. 16, 2011

(30) Foreign Application Priority Data
Feb. 17, 2010 (CA) 2694063

(51) Int. Cl. F16L 59/16; B21K 1/16; B21D 51/16

(52) U.S. Cl. 285/47; 29/890.149

(57) ABSTRACT

A one-piece shaped aluminum or stainless steel half fitting for an insulated pipe. The method may include cutting a predetermined sized blank from material stock. A top and a corresponding bottom die may be installed into a press along with a matching press plate. The predetermined sized blank may then be inserted onto the press plate and aligned with locating marks on the press plate. Once the blank is installed properly into the press, the method may further include cooperatively bringing the top and bottom dies together to press the blank into a specifically shaped half fitting. When pressed, excess flange material may be created along the perimeter of the fitting shape and excess end portion material is created at end portions of the fitting shape. The top die may then be separated from said bottom die and the shaped half fitting may then be removed from the press. The method may further include trimming the excess flange material and excess end portion material from the shaped half fitting.

### CROSS-REFERENCE TO RELATED APPLICATIONS

This application claims priority of Canadian patent application No. 2,694,063, filed Feb. 17, 2010, the entire contents of which are hereby incorporated by reference.

### FIELD OF THE INVENTION

The invention relates to the field of fittings for insulated pipes and in particular, a one-piece half fitting for insulated pipes.

### BACKGROUND OF THE INVENTION

The piping industry regularly employs a mechanical bolted coupling to join various pipes together. One exemplary coupling system, known as a Victaulic™ grooved piping method, employs a mechanical coupling that engages into grooves cut into the ends of corresponding pipes. A gasket seal is placed on the outside diameter of the pipes between the grooves and a sealing action is enhanced as the couplings are tightened by line-operating pressure or vacuum.

This grooved piping method dramatically reduces the amount of installation time as compared to welding, threading or flanging, is now used extensively for HVAC, plumbing, fire protection, water and wastewater treatment, oil field operations, mining, industrial processes, power plants, military and marine systems, and other demanding fluid-handling applications.

Other known methods for joining pipes together are also employed.

Once pipes are joined together, such as by a Victaulic™ coupling, the pipes and any coupling are insulated from external elements. To hold the insulation in place and to protect the insulation from mechanical abuse and the external elements, shaped fittings are placed over the insulation covering the pipes and couplings. Traditionally, the piping and fitting industry have used fittings made from polyvinylchloride (PVC) as these types of fittings are easy to manufacture into the required shapes. However, when exposed to external elements, PVC fittings demonstrate significant drawbacks. For example, in extreme temperature conditions, the PVC fittings will deteriorate and will start to sag or crack. Furthermore, PVC fittings discolor over time which detracts from their aesthetic appeal.

Accordingly, a need exists for a fitting which overcomes the disadvantages of traditional PVC fittings. Other objects of the invention will be apparent from the description that follows.

### SUMMARY OF THE INVENTION

According to one aspect of the present invention there is provided a one-piece Victaulic™ shaped half fitting for an insulated pipe made out of aluminum. The aluminum may range between and include 1050 and 3105 grade series aluminum. Preferably, the aluminum is 1100 or 3003 grade series aluminum.

According to another aspect of the present invention there is provided a use of aluminum in a method of forming a one-piece Victaulic™ shaped half fitting for an insulated pipe. The use may include using aluminum which ranges between and include 1050 and 3105 grade series aluminum. Preferably, the use includes using 1100 or 3003 grade series aluminum.

According to yet another aspect of the present invention there is provided a method of forming a one-piece Victaulic™ shaped aluminum half fitting for an insulated pipe. The method may include cutting a predetermined sized blank from a coil of aluminum stock. A top and a corresponding bottom die may be installed into a press along with a matching press plate. The predetermined sized aluminum blank may then be inserted onto the press plate and aligned with locating marks on the press plate. Once the blank is installed properly into the press, the method may further include cooperatively bringing the top and bottom dies together to press the aluminum blank into a specific Victaulic™ shaped half fitting. When pressed, excess flange material may be created along the perimeter of the half fitting shape and excess end portion material may be created at end portions of the half fitting shape. The top die may then be separated from the bottom die and the Victaulic™ shaped aluminum half fitting may then be removed from the press. The method may further include trimming the excess flange material and excess end portion material from the Victaulic™ shaped aluminum half fitting.

In certain situations lubricating oil may be applied to the dies and the blank. The blank may also be heated before it is inserted into the press and the press and press plate themselves may also be warmed prior to operation of the press.

Throughout the operation of the press, it may be necessary to adjust the hydraulic clamping pressure of the press in accordance with ambient and/or hydraulic oil temperatures.

Depending on the particular shape of the fitting required, relief cuts may be made in the blank prior to forming the aluminum fitting.

The method may also include re-pressing the aluminum half fitting in the press after trimming the excess flange material.

To allow the half fitting to mate with a corresponding half, divots in the aluminum half fitting may be made to match with a corresponding mating half.

Other aspects of the invention will be appreciated by reference to the detailed description of the preferred embodiment and to the claims that follow.

### BRIEF DESCRIPTION OF THE DRAWINGS

The preferred embodiment of the invention will be described by reference to the drawings thereof in which:

FIG. 1 is a top plan view of an aluminum blank for a 90° Victaulic™ half fitting of the present invention;

FIG. 2 is a top plan view of a Victaulic™ shaped half fitting formed from the blank of FIG. 1;

FIG. 3 is a top plan view of the final shape of the Victaulic™ shaped half fitting of FIG. 2;

FIG. 4 is a bottom perspective view of the Victaulic™ shaped half fitting of FIG. 2; and

FIG. 5 is a perspective view of a one-piece half fitting according to a further embodiment of the invention.

### DESCRIPTION OF THE PREFERRED EMBODIMENT OF THE INVENTION

Traditionally, due to its ease of manufacture and use, PVC has been extensively employed in forming Victaulic™ shaped fittings. However, PVC fittings have a number of drawbacks most notably, their susceptibility to external conditions and temperatures, lack of structural strength and inability to resist mechanical damage.

On the other hand, given the material's inherent properties, aluminum is an ideal material for Victaulic™ shaped fittings. Although aluminum is an ideal material for Victaulic™ shaped fittings, it is not considered by the piping and fitting industry as a workable solution as no-one has been able to form a one-piece aluminum fitting. The marketplace today is dominated by PVC fittings with a small smattering of other fitting materials. Although some may have attempted to manufacture an aluminum fitting in the past, these fittings comprise of multiple pieces riveted together. A riveted fitting is not only aesthetically displeasing, but is also less efficient at insulating a pipe fitting than a one-piece unit. Additionally, a riveted fitting or field applying fitting requires larger pieces of pipe insulation, multiple aluminum end caps, a regular pressed fitting and pieces of aluminum to join all of the pieces together. These pieces must either be screwed or banded together and caulked to prevent ingress of water. Moreover, a person skilled in the art must be employed to perform this task which is very costly and time consuming.

The present invention overcomes the disadvantages of all prior pipe fittings by providing a method of forming a one-piece Victaulic™ shaped aluminum half fitting for an insulated pipe. The aluminum ranges between and includes 1050 and 3105 grade series aluminum. This range of aluminum offers a balance between the workability and the strength characteristics necessary for the formation of a one-piece Victaulic™ shaped half fitting. Preferably, the aluminum is 1100 or 3003 grade series aluminum.

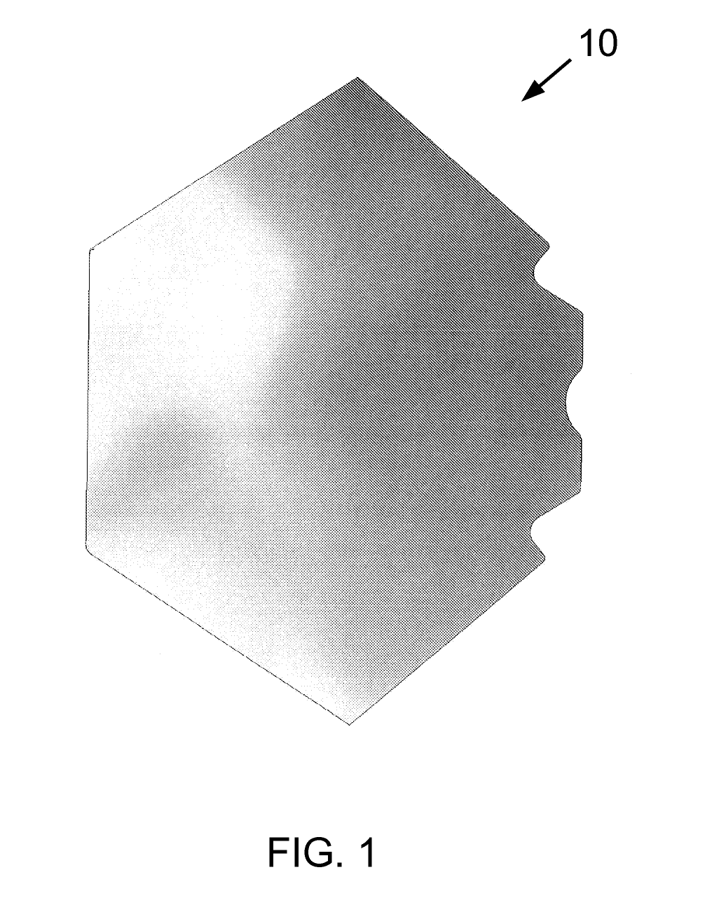

Referring to FIG. 1, a predetermined sized blank 10 is cut from a coil of aluminum stock. The exact size and shape of the blank 10, as those skilled in the art will appreciate, depends on the type of pipe fitting required; for example, a T-fitting requires more material and a different shape than a simple 45° fitting. As those skilled in the art will also appreciate, depending on the particular shape of the half fitting required, relief cuts (not shown) may be made in the blank 10 prior to forming the half fitting.

Top and a bottom dies are installed into a press along with a matching press plate. The blank 10 is then inserted onto the press plate and aligned with locating marks on the press plate. To prevent damage to the dies, lubricating oil may be applied to both dies and the blank 10 to enable the blank to more easily slide over and into the dies. During the winter months, the blank 10 may be warmed up to warm the epoxy film in order to prevent it from cracking during the formation process. The press and press plate may also be warmed up before operation to prevent the aluminum blank 10 from cooling too fast during the formation process.

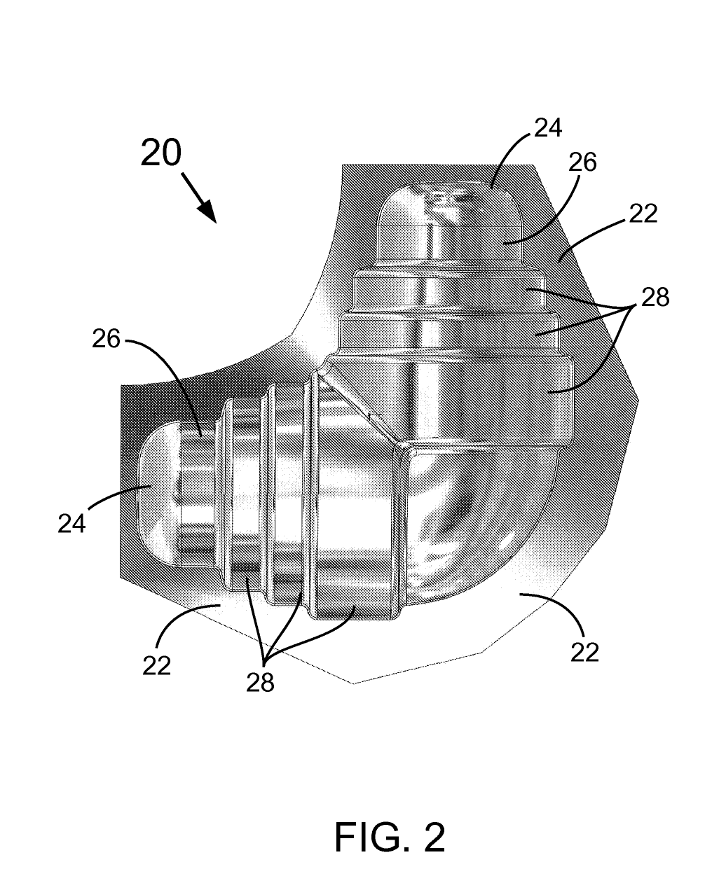

Once the blank 10 is installed properly into the press, the press is operated to bring the top and bottom dies together to press the aluminum blank into a specific Victaulic™ shaped half fitting 20, as shown in FIG. 2, in this case a 90° fitting. In one embodiment, the top die is brought down to hold the blank against the press plate. Once contact between the top die and the press plate is made the bottom, in this embodiment, a male die, is raised into the top die, in this embodiment, a female die forming the shape of the half fitting 20. Throughout the operation of the press, as those skilled in the art will appreciate, it may be necessary to adjust the hydraulic clamping pressure of the press in accordance with ambient and/or hydraulic oil temperatures to ensure the press is properly clamping down on the blank.

During the formation process, the press “stretches” the aluminum blank 10 around the male die and creates excess flange material 22 along the perimeter of the half fitting shape 20 and excess end portion material 24 is created at end portions 26 of the fitting shape. This accomplished as the aluminum blank 10 is held back by the pressure applied from the top die to the press plate which allows the aluminum blank 10 to stretch and form. To create the excess flange 22 and end portion 24 material it is important to properly size and shape the initial aluminum blank 10. Too small of a blank will result in an improperly formed half fitting as the aluminum will not fully “stretch” into the desired shape. On the other hand, too large of a blank will result in overly wasted material and rejected product due to tears formed in the blank from the high clamping force required to hold a large blank. The exact size and shape of the initial aluminum blank, as those skilled in the art will appreciate, can be determined in a variety of ways for example, computer modeling or simply by trial and error.

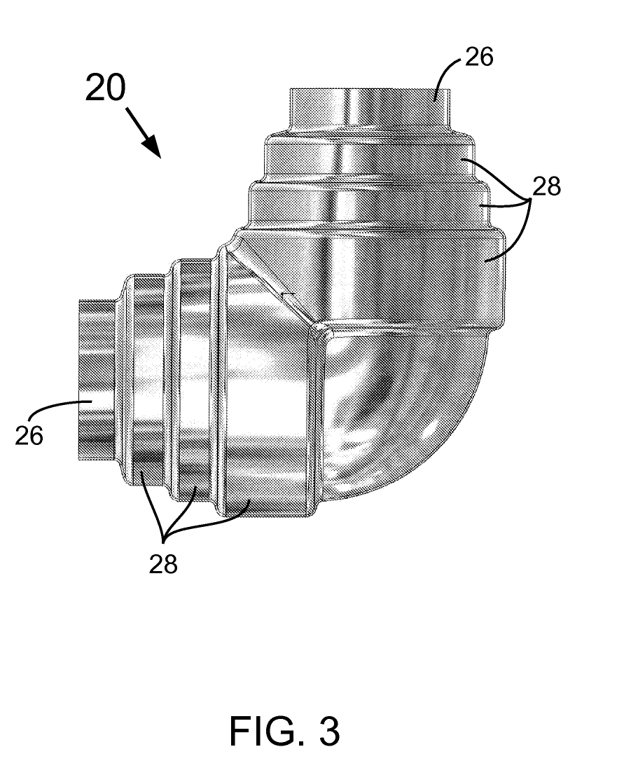

Once the half fitting 20 is formed by the press, the dies are separated from one-another and the Victaulic™ shaped aluminum half fitting may then be removed from the press and sent for trimming. At the trimming stage, excess flange material 22 and excess end portion material 24 are trimmed from the half fitting 20 to create its final shape, as shown in FIG. 3. In some instances, the half fitting 20 may require re-pressing after trimming the excess flange material 22. Re-pressing the half fitting 20 ensures that each of the Victaulic™ steps 28 have flat-rounded surfaces rather than concave/convex-rounded surfaces.

To form a mating fitting half, the above steps are repeated and divots 30 in the aluminum half fitting 20 may be made to match with the corresponding mating half.

While exemplary embodiments of the present invention are described herein above as Victaulic™ shaped aluminum half fittings, such embodiments, with our without modification, may be suitably employed as shaped aluminum half fittings applied to pipe couplings or joints other than Victaulic™ couplings. For example, the half fittings described herein above and shown in FIGS. 1 to 3 are suitable for use as shaped aluminum half fittings applied over insulated joints of outdoor refrigeration pipes and piping systems not employing Victaulic™ couplings. Such refrigeration pipes and piping systems may be substantially made of copper and insulated using foam rubber, for example. By way of further example, the half fittings described herein above and shown in FIGS. 1 to 3 are suitable for use as shaped aluminum half fittings applied to welded pipe not employing Victaulic™ couplings, for example.

Half fittings in accordance with the present invention and suitable for use as shaped aluminum half fittings applied to pipe couplings or joints other than Victaulic™ couplings include T-shape fittings, 90° fittings, 45° fittings, and other suitable fittings, for example.

While embodiments of the present invention are described herein above as Victaulic™ shaped aluminum half fittings and as shaped aluminum half fittings for couplings or joints other than Victaulic™ couplings, embodiments of the present invention include half fittings made of materials other than aluminum. For example, such embodiments of the present invention may be made of stainless steel, including stainless steel T304 or T316 for example. Polyurethane dies, including polyurethane dies typically employed to form the parts of an aluminum half fitting, may be suitably employed to form the parts of a stainless steel half fitting. Additionally or alternatively, dies made of steel may be employed to form the parts of a stainless steel half fitting, for example. Additionally or alternatively, dies made of a combination of polyurethane and steel may be employed to form the parts of a stainless steel half fitting, for example.

### Further Embodiments

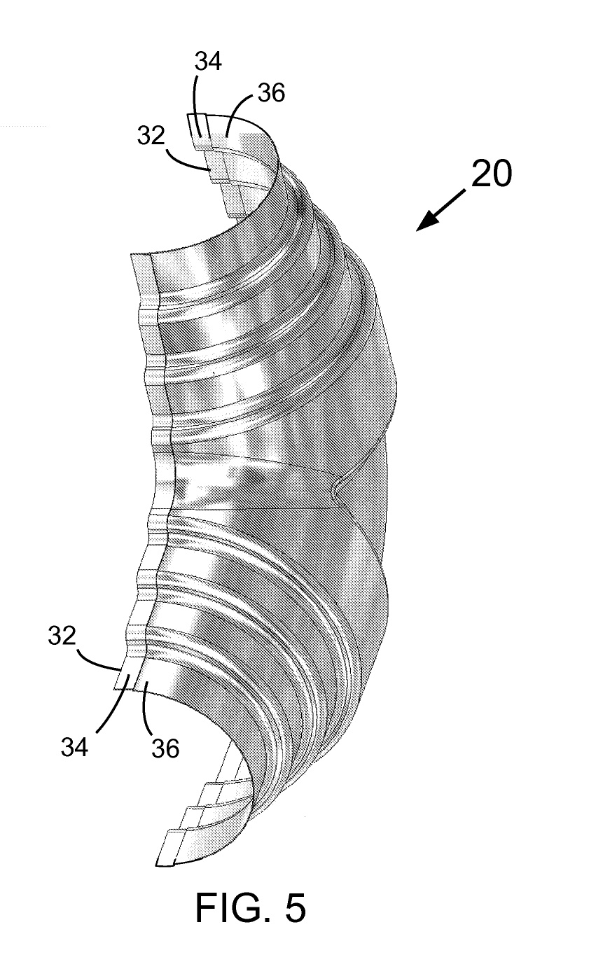

Referring to FIG. 5, a half fitting 20 may suitably be any of a Victaulic™ shaped aluminum half fitting, a shaped aluminum half fitting for couplings or joints other than Victaulic™ couplings, and a Victaulic™ or otherwise shaped half fitting made of a material other than aluminum.

The half fitting 20 shown in FIG. 5 includes along each of the opposing edges 32 a rib 34 for mating with a corresponding mating half (not shown in FIG. 5). The rib 34 in some embodiments is inwardly displaced relative to the adjacent portion 36 of the half fitting 20, and in some embodiments is outwardly displaced relative to the adjacent portion 36. The corresponding mating half may be unribbed (i.e. not have a rib 34) or may be ribbed in a matingly opposed direction relative to the rib 34 of the half fitting 20, for example.

FIG. 5 shows the width of the rib 34 as the shortest distance between the edge 32 and the adjacent portion 36 of the half fitting 20. In various embodiments, the rib 34 may have any suitable width and the rib 34 width may vary with the overall dimensions of the half fitting 20. For example, a half fitting 20 having a maximum diameter between 1⅛ inches and 4 inches may suitably include a rib 34 having a rib 34 width between ¼ inch and ⅜ inch; a half fitting 20 having a maximum diameter between 4½ inches and 8½ inches may suitably include a rib 34 having a rib 34 width between ½ inch and ⅝ inch; and a half fitting 20 having a maximum diameter equal to or greater than 8½ inches may suitably include a rib 34 having a rib 34 width equal to or greater than ¾ inch, including having a rib 34 width between ¾ inch and 1 inch.

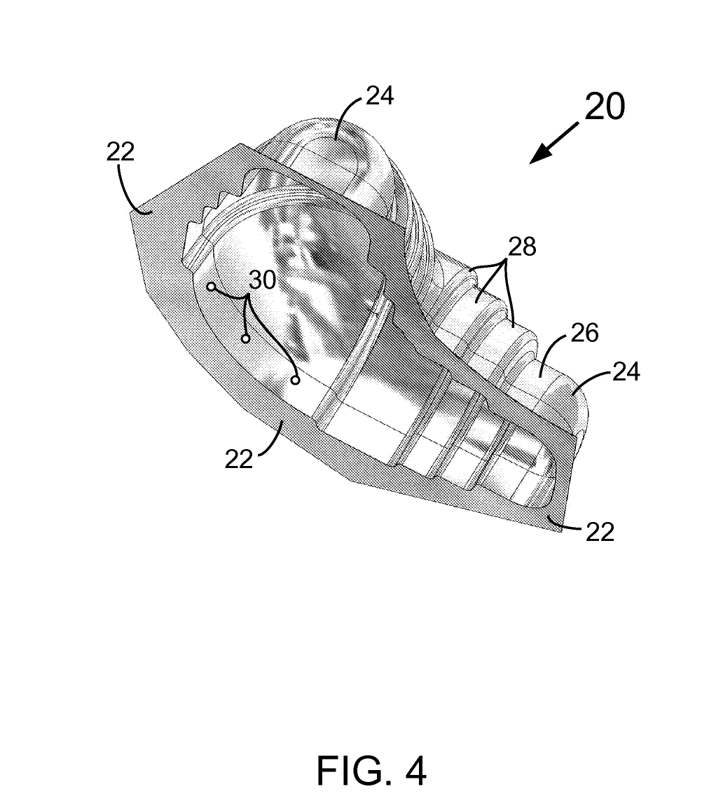

The ribs 34 may be formed during the trimming stage after the half fitting 20 has been created in accordance with the process described herein above (FIGS. 1 to 3). Typically, a half fitting 20 having the ribs 34 does not include the divots 30 (FIG. 4). In particular, after the half fitting 20 has been removed from the set of dies used to form the half fitting 20, the half fitting 20 is inserted into and pressed by a different set of dies or other clamping means which form the ribs 34. While the half fitting 20 is being held or otherwise clamped for forming the ribs 34, the excess flange material 22 (FIG. 2) may be trimmed from the half fitting 20. The half fitting 20 is then released having formed therein the ribs 34 and with the excess flange material 22 (FIG. 2) removed.

To form a corresponding mating half (not shown in FIG. 5), the above steps are repeated and the ribs 34 in the mating half fitting 20 may be made to match with the corresponding mating half.

It will thus be seen that a new and novel one-piece half fitting, including a Victaulic™ shaped aluminum half fitting, for an insulated pipe has been illustrated and described and it will be apparent to those skilled in the art that various changes and modifications may be made therein without departing from the spirit of the invention.

What is claimed is:

1. A method of forming a one-piece half fitting for an insulated pipe, the method comprising:
cutting a predetermined sized blank from a stock made of a material selected from the group consisting of aluminum and stainless steel;
installing a top and a corresponding bottom die into a press along with a matching press plate;
inserting said predetermined sized blank onto said press plate and ensuring said blank is in alignment with locating marks on said press plate;
cooperatively bringing said top and bottom dies together to press said predetermined sized blank into a shaped fitting, wherein excess flange material is created along the perimeter of said shaped fitting and excess end portion material is created at end portions of said shaped fitting;
separating said top die from said bottom die;
removing said shaped fitting from said press;
trimming said excess flange material from said shaped fitting; and
trimming said excess end portion material from said shaped fitting.

2. The method of claim 1 further comprising applying lubricating oil to said top die, said bottom die and said press plate, prior to inserting said predetermined sized blank onto said press plate.

3. The method of claim 1 further comprising heating said predetermined sized blank prior to inserting said predetermined sized blank onto said press plate.

4. The method of claim 1 further comprising warming said press prior to pressing said predetermined sized blank into said shaped fitting.

5. The method of claim 3 further comprising warming said press plate prior to inserting said predetermined sized blank onto said press plate.

6. The method of claim 1 further comprising adjusting a hydraulic clamping pressure of said press in accordance with ambient temperatures.

7. The method of claim 1 further comprising adjusting a hydraulic clamping pressure of said press in accordance with hydraulic oil temperatures.

8. The method of claim 1 further comprising making relief cuts in said predetermined sized blank prior to pressing said predetermined sized blank into said shaped fitting.

9. The method of claim 1 further comprising re-pressing said shaped fitting in said press after trimming said excess flange material.

10. The method of claim 1 further comprising forming divots in said shaped fitting so as to permit the one-piece half fitting to match with a corresponding mating half.

11. The method of claim 1 wherein cooperatively bringing said top and bottom dies together to press said predetermined sized blank into a shaped fitting, wherein excess flange material is created along the perimeter of said shaped fitting and excess end portion material is created at end portions of said shaped fitting, comprises pressing said predetermined sized blank into said shaped fitting defining a rib along each of opposing edges of said shaped fitting so as to permit the one-piece half fitting to match with a corresponding mating half.

12. Use of aluminum in the method according to claim 1 of forming a one-piece half fitting for an insulated pipe.

13. The use of claim 12 wherein said aluminum is within a range of between and including 1050 and 3105 grade series aluminum.

14. The use of claim 13 wherein said aluminum comprises 1100 grade series aluminum.

15. The use of claim 13 wherein said aluminum comprises 3003 grade series aluminum.

16. A one-piece half fitting for an insulated pipe formed in accordance with the method of claim 1.

17. The one-piece half fitting of claim 16 wherein the material is within a range of between and including 1050 and 3105 grade series aluminum.

18. The one-piece half fitting of claim 17 wherein the material comprises 1100 grade series aluminum.

19. The one-piece half fitting of claim 17 wherein the material comprises 3003 grade series aluminum.

20. The one-piece half fitting of claim 16 wherein the material comprises stainless steel.
